(19) United States
(12) Patent Application Publication
(10) Pub. No.: US 2002/0158883 A1
(43) Pub. Date: Oct. 31, 2002

(54) Control of brightness and contrast by averaging

(75) Inventors: Yann Cheri, Montpellier (FR); Thierry Escande, Montpellier (FR)

Correspondence Address: Alistair K. Chan, FOLEY & LARDNER, Firstar Center, 777 East Wisconsin Avenue, Milwaukee, WI, 53202-5367, US

(73) Assignee: Palm, Inc.

(21) Appl. No.: 09/842,561

(22) Filed: Apr. 25, 2001

(51) Int. Cl. G09G 5/02

(52) U.S. Cl. 345/589

(57) ABSTRACT

A handheld computer is disclosed including a housing, a display supported by the housing, and computing electronics supported by the housing and configured to communicate with the display. The handheld computer further includes at least two light sensors configured to provide input to the computing electronics and are configured to adjust at least one of a brightness factor of the display and a contrast factor of the display based on the input of the at least two light sensors.

### BACKGROUND

Handheld computing devices, “palmtops”, “palmhelds”, personal digital assistants (PDAs), or handheld computers typically weigh less than a pound and fit in a pocket. These handhelds generally provide some combination of personal information management, database functions, word processing, and spreadsheets. Because of the small size and portability of handhelds, strict adherence to hardware constraints, such as display device hardware, must be maintained.

It is known to provide control systems for use in conjunction with the display device hardware. Such systems are used to adjust the brightness and/or contrast of a display. Typically, the control systems use a single light intensity sensor to provide the control signal while controlling the display device hardware or the control systems employ manual controls for adjusting brightness and contrast.

Typical control systems are not well suited to automatically adjust the properties and characteristics of the display device hardware under dynamic, and varied lighting conditions.

Accordingly, there is a need for a control system for a handheld computing device that is well suited to automatically adjust the properties and characteristics of a display, and is configured to generate a proper display control signal under dynamic, and varied lighting conditions. Further there is a need to provide an automatic control of brightness and contrast of a display.

The techniques herein below extend to those embodiments which fall within the scope of the appended claims, regardless of whether they accomplish one or more of the above-mentioned needs.

### SUMMARY

An exemplary embodiment relates to a handheld computer including a housing, a display supported by the housing, computing electronics supported by the housing and configured to communicate with the display. The handheld computer further includes at least two light sensors configured to provide input to the computing electronics. The computing electronics are configured to adjust at least one of a brightness factor of the display and a contrast factor of the display based on the input of the at least two light sensors.

Another exemplary embodiment relates to a method for controlling a display in a mobile electronic device including providing a first signal indicative of lighting conditions at a first position relative to the display device, providing a second signal indicative of lighting conditions at a second position relative to the display device. The method also includes generating a control signal based on the first and second signals, and adjusting at least one of a brightness factor of the display device and an intensity factor of the display device using the control signal.

Further, an exemplary embodiment relates to a method for controlling the display of a mobile electronic device including providing a first signal indicative of lighting conditions at a first position relative to the display device, providing a second signal indicative of lighting conditions at a second position relative to the display device, providing a third signal indicative of lighting conditions at a third position relative to the display device, and providing a fourth signal indicative of lighting conditions at a fourth position relative to the display device. The method also includes generating a control signal using the first, second, third and fourth signals, and adjusting at least one of a brightness factor of the display device and an intensity factor of the display device using the control signal.

### BRIEF DESCRIPTION OF THE DRAWINGS

The invention will become more fully understood from the following detailed description, taken in conjunction with the accompanying drawings, wherein like referenced numerals refer to like elements, in which:

FIG. 1 is a front perspective view of a handheld computer;

FIG. 2 is a block diagram of an exemplary communications bus architecture for the handheld computer of FIG. 1;

FIG. 3 is an exemplary block diagram depicting a display control for the handheld computer of FIG. 1; and

FIG. 4 is a perspective view of an alternative embodiment of a handheld computer.

### DETAILED DESCRIPTION OF EXEMPLARY EMBODIMENTS

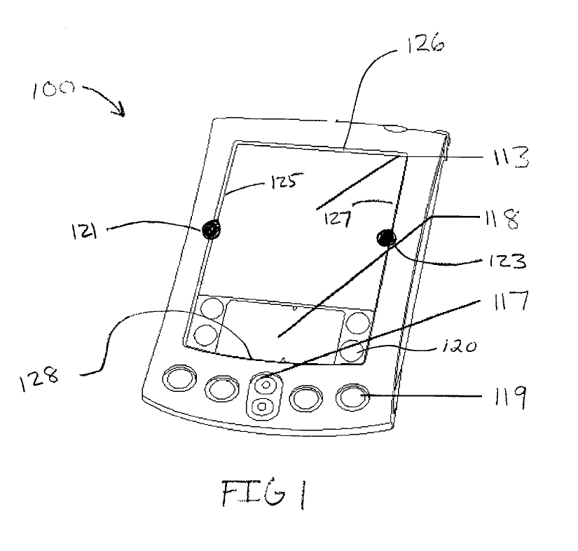

Referring to FIG. 1, a handheld computer 100 is depicted, according to an exemplary embodiment. Handheld computer 100 may include Palm™ style computers manufactured by Palm, Inc., of Santa Clara, Calif. Other exemplary embodiments of the invention may include windows CE™, handheld computers or other handheld computers or personal digitals assistants, as well as cellular telephones, and other mobile computing devices.

Preferably, handheld computer 100 includes interactive hardware and software that performs functions such as maintaining calendars, phone lists, task lists, notepads, calculation applications, spreadsheets, games, and other applications capable of running on a computing device. Handheld computer 100, depicted in FIG. 1 includes a plurality of input functions, keys 119 and a display 113 having graphical user interface features. Display 113 may be provided with an interface that allows a user to select an altered display content using a pointer, such as, but not limited to, a stylus. In an exemplary embodiment, display 113 also includes a Graffiti™ writing section 118, or other hand recognition software, for tracing alpha numeric characters as input. A plurality of input buttons 120 for performing automated or preprogrammed functions may be provided on a portion of display 113. In a particular embodiment, display 113 is a touch screen display that is electronically responsive to movements of a stylus (or other pointing device, such as but not limited to a fingertip or pen tip) on the surface of display 113. Display 113 may be a liquid crystal display (LCD), a thin film transistor (TFT) display, a micro-machine mirror display, and other backlit, side lit, refractive or reflective displays.

As depicted in FIG. 1, handheld computer 100 includes sensors 121 and 123. In an exemplary embodiment, sensors 121 and 123 may be photoelectric sensors which provide a signal output indicative of the light intensity. For example, sensors 121 and 123 may be any of a variety of photoelectric sensors which provide a varying level electrical signal as an output, and may be correlated to the light intensity which the photoelectric sensor is subjected to. Other types of light sensors may also be applied to the task of sensing light intensity and converting such light intensity to a signal that may be interpreted by a processing device.

Sensor 121 may be located near an edge 125 of display 113. Sensor 123 may be located near an edge 127 of display 113. In an exemplary embodiment, sensors 121 and 123 are located near an edge of display 113. Alternatively, sensors 121 and 123 may be located any distance away from display 113 sufficient to provide an accurate signal as to the light intensity which display 113 is subjected to.

Sensors 121 and 123 are depicted as being disposed on opposing edges 125 and 127 of display 113. As shown in FIG. 1, opposing edges 125 and 127 are left and right hand edges of display 113. In an exemplary embodiment, sensors 121 and 123 are disposed in the middle of edges 125 and 127. Alternatively, sensors 121 and 123 may be disposed on opposing edges 126 and 128 (upper and lower edges of display 113). Furthermore, sensors 121 and 123 may be disposed in any location away from display 113, or at any location along edges 125, 126, 127, or 128. Further, sensors 121 and 123 may be incorporated into display 113 itself, being disposed beneath the display glass, e.g. light may be transmitted through the display glass to a sensor located beneath the display glass and disposed within the housing.

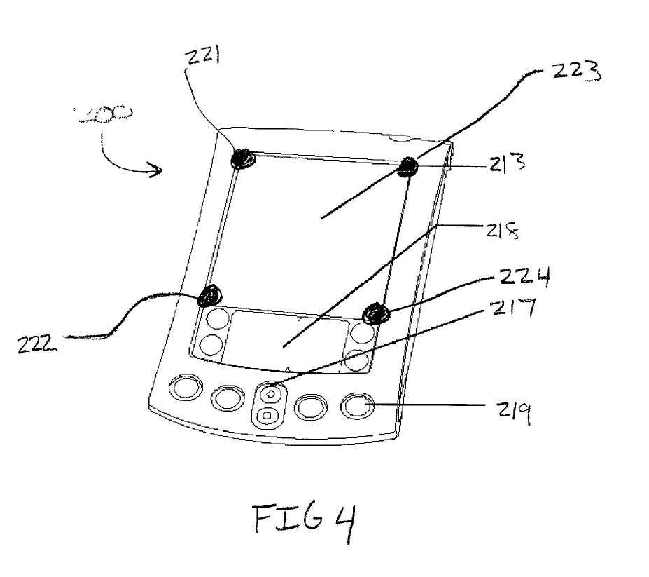

In another exemplary embodiment, depicted in FIG. 4, handheld computer 200 includes sensors 221, 222, 223, and 224. Sensor 221 may be located near an upper left corner of display 213. Sensor 222 may be located near a lower left corner of display 213. Sensor 223 may be located near an upper right corner of display 213. Sensor 224 may be located near a lower right corner of display 213.

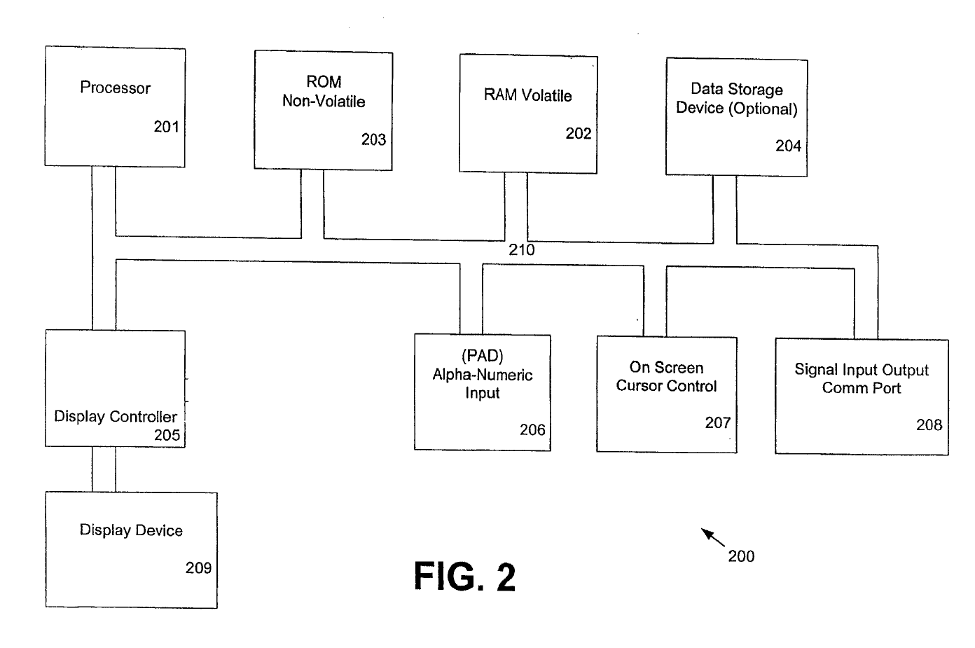

Referring to FIG. 2, an exemplary communication bus architecture 200 for handheld computer 100 is depicted. Bus architecture 200 includes a processor 201, a random access volatile memory 202, a read-only non-volatile memory (ROM) 203, a data storage device 204 which may be an optional device, such as a disk drive, hard disk drive, optical disk drive, flash memory, or the like. Processor 201, RAM 202, ROM 203, and data storage device 204, are coupled to and in communication with a communications bus 210. Further, coupled to and in communication with communications bus 210 are a display controller 205, an alphanumeric input 206, an on-screen cursor control 207, and a signal input/output communications port 208. Yet further still, display device 209 is coupled to display controller 205 (display controller 205 may be, but is not limited to, a Seiko Epson 1375 display controller).

In operation, processor 201 runs program applications stored in ROM 203, RAM 202, and/or data storage device 204. Many of these applications require screen displays. For example, some applications, such as, but not limited to, memo pads, date books, contacts or telephone books, etc., require images and textual types of graphical information to be displayed on display 113. However, during operation, the images or textual types of information may become more difficult to view. For example, if handheld computer 100 is used in direct sunlight, the images or textual types of information on display 113 may be obscured or washed out by the sunlight. Display controller 205 is configured to adjust a contrast factor and/or a brightness factor of display device 209 in order to compensate for lighting conditions. The brightness factor adjusted by display controller 205 adjusts the lightness of the images or textual types of information. The contrast factor adjusted by display controller 205 adjusts the relative brightness between two pixels of the images or textual types of information. In the exemplary embodiment of FIG. 2, display controller 205 (or processor 201) is configured to run a display logic (or other software for controlling display 13) to provide display information to display device 209.

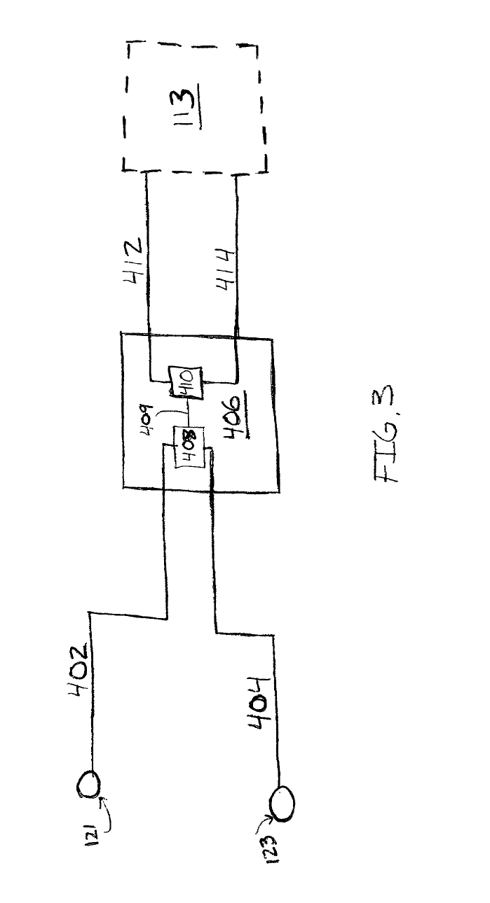

Referring to FIG. 3, a block diagram depicting data flow for display controller 205 of handheld computer 100 is depicted. Display control 205 includes signals 402 and 404, algorithm 406, and control signals 410 and 412. Sensors 121 and 123, shown schematically in FIG. 4 provide signals 402 and 404 which are indicative of ambient lighting conditions at the physical locations of sensors 121 and 123. Due to the proximity of sensors 121 and 123 to display 113, signals 402 and 404 are also indicative of ambient lighting conditions near display 113.

Signals 402 and 404 are provided directly or transformed and provided as input to algorithm 406. In an exemplary embodiment, algorithm 406 includes an averaging step 408, and a correlation step 410. Averaging step 408 generates a conditioned signal 409 by computing the average (or mean) of signals 402 and 404. Conditioned signal 409 is provided as input to correlation step 410. Correlation step 410 generates control signals 410 and 412 using a look up table to correlate conditioned signal 409 to appropriate control signals 412 and 414. In an exemplary embodiment, control signal 412 is a brightness control signal, and control signal 414 is a contrast control signal. Control signal 412 is used to control the brightness of display 113, and control signal 414 is used to control the contrast of display 113.

In alternative embodiments, averaging step 408 may be replaced with other computational steps such as weighted averaging, using a look up table based on signals 402 and 404, various mathematical function, etc. Furthermore, correlation step 410 may be replaced with alternative correlative steps such as functional correlations, mathematical and/or electrical transformation, and the like.

Averaging step 408 allows display controller 205 to accommodate and adapt to varied and dynamic lighting conditions. For example, if a handheld computer was being used next to a window, ambient sunlight may strike across a portion of the display. There may also be a portion of the display that is in a shadow (i.e. not direct sunlight). By providing multiple photoelectric sensors, a more accurate estimate of the lighting conditions the display is exposed to may be developed. A more accurate estimate of the lighting conditions allows the display controller to more accurately control the brightness and contrast of the display. This results in improved display of textual and graphic images on the display. In the case that a single light sensor is used, proper adjustment of the brightness and/or contrast may not be made, for example when the single sensor is obscured by a shadow, a finger, or other object, or the like. Accordingly, accommodating more than one sensor, although redundant, provides an improved contrast and/or brightness adjustment mechanism for a handheld computer or other mobile electronic device utilizing a display. In a further exemplary embodiment, in the use of multiple light sensors, a redundant sensor reading may be removed from use or ignored under certain circumstances. For example, if three sensors indicated a high light intensity and a fourth sensor indicated an extremely low light intensity, it may be desirable to include logic that ignores the fourth sensor reading. Any of various logic algorithms may be applied to ignore or identify aberrant light intensity readings.

While the detailed drawings, specific examples and particular formulations given describe exemplary embodiments, they serve the purpose of illustration only. The hardware and software configurations shown and described may differ depending on the chosen performance characteristics and physical characteristics of the computing devices. For example, the type of computing device or communications bus used may differ. The systems shown and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A handheld computer, comprising:
a housing;
a display supported by the housing;
computing electronics supported by the housing and configured to communicate with the display;
at least two light sensors configured to provide input to the computing electronics;
wherein the computing electronics are configured to adjust at least one of a brightness factor of the display and a contrast factor of the display based on the input of the at least two light sensors.

2. The handheld computer of claim 1, wherein the at least two light sensors are disposed near opposing edges of the display.

3. The handheld computer of claim 1, wherein the at least two light sensors further comprise four light sensors disposed on corners of a perimeter of the display.

4. The handheld computer of claim 3, wherein the at least two light sensors are photoelectric sensors.

5. The handheld computer of claim 4, wherein the computing electronics are configured to adjust the brightness factor and the contrast factor of the display based on the input of the at least two light sensors by averaging the at least two signals to generate a control signal.

6. The handheld computer of claim 5, further comprising providing the average of the at least two signals to an algorithm configured to generate a control signal.

7. The handheld computer of claim 1, wherein the display is one of an LCD and a TFT display.

8. A method for controlling a display in a mobile electronic device, comprising:
providing a first signal indicative of lighting conditions at a first position relative to the display device;
providing a second signal indicative of lighting conditions at a second position relative to the display device;
generating a control signal based on the first and second signals; and
adjusting at least one of a brightness factor of the display device and an intensity factor of the display device using the control signal.

9. The method of claim 8, wherein generating a control signal further comprises averaging the first and second signals.

10. The method of claim 8, wherein generating a control signal further comprises accessing a look up table based on the first and second signals to determine the control signal.

11. The method of claim 8, wherein generating a control signal further comprises providing the first and second signals to an algorithm configured to determine the control signal.

12. The method of claim 8, wherein generating a control signal further comprises generating a brightness control signal and a contrast control signal.

13. A method for controlling the display of a mobile electronic device, comprising:
providing a first signal indicative of lighting conditions at a first position relative to the display device;
providing a second signal indicative of lighting conditions at a second position relative to the display device;
providing a third signal indicative of lighting conditions at a third position relative to the display device;
providing a fourth signal indicative of lighting conditions at a fourth position relative to the display device;
generating a control signal using the first, second, third and fourth signals; and
adjusting at least one of a brightness factor of the display device and an intensity factor of the display device using the control signal.

14. The method of claim 13, wherein generating a control signal further comprises averaging the first, second, third and fourth signals.

15. The method of claim 13, wherein generating a control signal further comprises accessing a look up table based on the first, second, third and fourth signals to determine the control signal.

16. The method of claim 13, wherein generating a control signal further comprises providing the first, second, third and fourth signals to an algorithm configured to determine the control signal.

17. The method of claim 13, wherein generating a control signal further comprises generating a brightness control signal and a contrast control signal.
